(19) United States
(12) Patent Application Publication
(10) Pub. No.: US 2026/0201095 A1
(43) Pub. Date: Jul. 16, 2026

(54) METHOD FOR MANUFACTURING FLUOROELASTOMERS IN AQUEOUS EMULSION WITHOUT USING FLUORINATED SURFACTANTS

(71) Applicant: SYENSQO SPECIALTY POLYMERS ITALY S.P.A., Bollate (Milano) (IT)

(72) Inventors: Fiorenza D'Aprile, Nova Milanese (MI) (IT); Alessio Marrani, Lecco (LC) (IT)

(73) Assignee: SYENSQO SPECIALTY POLYMERS ITALY S.P.A., Bollate (Milano) (IT)

(21) Appl. No.: 19/134,661

(22) PCT Filed: Nov. 9, 2023
(86) PCT No.: PCT/EP2023/081290

§ 371 Date: May 30, 2025

(30) Foreign Application Priority Data
Nov. 30, 2022 (EP) 22210470.5

(51) Int. Cl. C08F 214/22; C08K 5/092

(52) U.S. Cl. CPC C08F 214/22; C08K 5/092; C08F 2800/10

(57) ABSTRACT

The present invention relates to a method for manufacturing fluoroelastomers via emulsion polymerization in the absence of fluorinated surfactants and in the presence of one or more polycarboxylic acid having from 2 to 22 carbon atoms. The invention also relates to an aqueous fluoroelastomer latex and to a fluoroelastomer which can be obtained from the process.

### TECHNICAL FIELD

The present invention relates to a method for manufacturing fluoroelastomers, notably vinylidene fluoride (VDF)-based fluoroelastomers, in emulsion polymerization wherein no addition of fluorosurfactants is required, and wherein a very stable fluoropolymer latex can be obtained.

### BACKGROUND ART

This application claims priority from the European Patent Application 2210470.5, filed on 2022 Nov. 30, the whole content of this application being incorporated herein by reference for all purposes.

Vulcanized fluoroelastomers have been used in a variety of applications, in particular for manufacturing sealing articles such as oil seals, gaskets, shaft seals and O-rings, because of several desirable properties such as heat resistance, chemical resistance, weatherability, etc.

A frequently used method for manufacturing curable fluoroelastomers, involves aqueous emulsion polymerization of one or more fluorinated monomers. This type of polymerization is generally carried out in the presence of fluorinated surfactants, which are required for ensuring latex stability, increasing kinetics, and avoiding build-up or fouling of the reactors.

For example, US 2007/0100062 (DuPont Performance Elastomers L.L.C.) discloses fluoroelastomers prepared by emulsion polymerization. While it is broadly disclosed that surfactants are optional ingredients, all the examples requires the use of a fluorinated surfactant (eg., perfluoro hexyl ethyl sulfonic acid). More recently, because of increasing concerns related the use of fluorinated surfactants, reactions requiring non fluorinated surfactants have been disclosed in the art, for example in US 2018/0237628 and US 2018/0148527 (both in the name of Asahi Glass Company, Limited and describing TFE based fluoroelastomers).

When targeting manufacture of stable latexes of VDF based fluoroelastomers in the absence of added fluorinated surfactants, the current state of the art still does not provide for methods of making such fluoroelastomers as latexes having outstanding stability.

Now, surprisingly, the Applicant found that this problem can be effectively solved by the method of the present invention. Such method also allows obtaining fluoroelastomer latexes having a very small average particle size, which generates latexes which are easier to handle, and fluoroelastomers having an outstanding chemical resistance especially to polar solvents.

### SUMMARY OF THE INVENTION

The present invention relates to a method of making a fluoroelastomer [fluoroelastomer A] in an aqueous reaction medium free from fluorinated surfactants, said method comprising:
a: forming an aqueous emulsion comprising:
   i) one or more polycarboxylic acid having from 2 to 22 carbon atoms, in acid or salt form,
   iii) a free-radical initiator,
   ii) monomers comprising vinylidene fluoride (VDF) and one or more fluorinated monomer different from VDF,
   iv) optionally a chain transfer agent;
b: initiating the polymerization of said monomers, thereby forming a fluoroelastomer A as a stable latex wherein:
said fluoroelastomer A comprises 30-80% by moles of recurring units derived from vinylidene fluoride (VDF), and 20-70% by moles of recurring units derived from one or more fluorinated monomer different from VDF.

Also the present invention relates to an aqueous latex free from fluorinated surfactants, comprising one or more polycarboxylic acid having from 2 to 22 carbon atoms, in acid or salt form, and particles of a fluoroelastomer A, wherein said particles of fluoroelastomer A have an average particle size, measured according to ISO 13321, below 400 nm and wherein said fluoroelastomer A:
comprises 30-80% by moles of recurring units derived from VDF, 20-70% by moles of recurring units derived from one or more fluorinated monomer different from VDF,
possesses a Mooney viscosity (ML1+10 (121° C.)) of at least 10 MU;
comprises —CH₂OH chain ends in an amount of zero to less than 10 mmol/kg of fluoroelastomer A, preferably less than 5 mmol/kg of fluoroelastomer A.

The present invention also relates to a fluoroelastomer possessing a Mooney viscosity (ML1+10 (121° C.)) of at least 10 MU and comprising:
30-80% by moles of recurring units derived from VDF, 20-70% by moles of recurring units derived from one or more fluorinated monomer different from VDF,
—CH₂OH chain ends in an amount of zero to less than 10 mmol/kg of fluoroelastomer A, preferably less than 5 mmol/kg of fluoroelastomer A;
hydrogen-comprising chain ends selected from the group consisting of —CF₂H and —CF₂CH₃ in an amount of 15 to 100 mmol/kg of fluoroelastomer A.

In another aspect the present invention relates to a curable composition comprising fluoroelastomer A and one or more curing agents.

A method of making a cured part, and a cured part obtained from the curable composition above are additional objects of the present invention.

### DESCRIPTION OF EMBODIMENTS

For the purposes of the present description and of the following claims:
the use of parentheses around symbols or numbers identifying the formulae, for example in expressions like “fluoroelastomer (A)”, etc., has the mere purpose of better distinguishing the symbol or number from the rest of the text and, hence, said parenthesis can also be omitted;
the expression “essentially consists of”, when used in combination with repeat units of fluoroelastomer A, is intended to indicate that minor amounts of end chains, defects, irregularities and monomer rearrangements are tolerated in fluoroelastomer A, provided that their amount is below 5 moles % based on the total moles of the fluoroelastomer A, more preferably below 2 moles %, even more preferably below 1 moles %;
the term “fluoroelastomer” is intended to indicate essentially amorphous polymer(s), preferably having a low degree of crystallinity (having a heat of fusion of less than 5 J/g, preferably of less than 3 J/g, more preferably of less than 1 J/g, as measured by ASTM D-3418) and a glass transition temperature (Tg) below room temperature, as measured by ASTM D-3418. The fluoroelastomer has advantageously a Tg below 10° C., preferably below 5° C., more preferably below 0° C.;
the expressions “fluorinated surfactant” “fluorinated monomer” and similar, are intended to encompass partially and fully fluorinated compounds, unless otherwise specified.

The method of the present invention is suitable to prepare, using emulsion polymerization in a fluorosurfactant free environment, fluoroelastomers having 30-80%, preferably 35-75%, more preferably 40-70%, even more preferably 45-65% by moles of recurring units derived from vinylidene fluoride (VDF), and 20-70%, 25-65%, more preferably 30-40%, even more preferably 35-55% by moles of recurring units derived from one or more fluorinated monomer different from vinylidene fluoride (VDF).

Non limitative examples of suitable fluorinated monomers different from VDF are notably:
(a) C₂-C₈ perfluoroolefins, such as tetrafluoroethylene (TFE) and hexafluoropropylene (HFP);
(b) hydrogen-containing C₂-C₈ olefins different from VDF, such as vinyl fluoride (VF), trifluoroethylene (TrFE), perfluoroalkyl ethylenes of formula CH₂═CH—R_{f}, wherein R_{f} is a C₁-C₆ perfluoroalkyl group;
(c) C₂-C₈ chloro and/or bromo and/or iodo-fluoroolefins such as chlorotrifluoroethylene (CTFE);
(d) (per)fluoroalkylvinylethers (PAVE) of formula CF₂═CFOR_{f}, wherein R_{f} is a C₁-C₆ (per)fluoroalkyl group, e.g. —CF₃, —C₂F₅, —C₃F₇;
(e) (per)fluoro-oxy-alkylvinylethers of formula CF₂═CFOX, wherein X is a C₁-C₁₂ [(per)fluoro]-oxyalkyl comprising catenary oxygen atoms, e.g. the perfluoro-2-propoxypropyl group;
(f) (per)fluorodioxoles having formula:

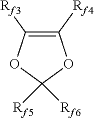

wherein R_{f3}, R_{f4}, R_{f5}, R_{f6}, equal or different from each other, are independently selected among fluorine atoms and C₁-C₆ (per)fluoroalkyl groups, optionally comprising one or more than one oxygen atom, such as notably —CF₃, —C₂F₅, —C₃F₇, —OCF₃, —OCF₂CF₂OCF₃; preferably, perfluorodioxoles;
(g) (per)fluoro-methoxy-vinylethers (MOVE, hereinafter) having formula: CFX₂═CX₂OCF₂OR″_{f} wherein R″_{f} is selected among linear or branched C₁-C₆ (per)fluoroalkyls; C₅-C₆ cyclic (per)fluoroalkyls; and C₂-C₆ (per)fluorooxyalkyls, linear or branched, comprising from 1 to 3 catenary oxygen atoms, and X₂═F, H; preferably X₂ is F and R″_{f} is —CF₂CF₃ (MOVE1); —CF₂CF₂OCF₃ (MOVE2); or —CF₃ (MOVE3).

It is generally preferred that said fluoroelastomer A comprises, in addition to recurring units derived from VDF, recurring units derived from HFP.

In this case, fluoroelastomer A typically comprises at least 10% moles, preferably at least 12% moles, more preferably at least 15% moles of recurring units derived from HFP, with respect to all recurring units of the fluoroelastomer A.

Still, fluoroelastomer A typically comprises at most 55% moles, preferably at most 45% moles, more preferably at most 35% moles of recurring units derived from HFP, with respect to all recurring units of the fluoroelastomer A.

Further, in some embodiments, such fluoroelastomer (A) may contain, in addition to recurring units derived from VDF and HFP monomers, recurring units derived from TFE, and/or CTFE. In this case fluoropolymer A typically comprises at least 2% moles, preferably at least 4% moles, more preferably at least 7% moles and at most 25%, preferably at most 20% moles, more preferably at most 15% moles of recurring units selected from TFE and CTFE.

Fluoroelastomer A may comprise, in addition to recurring units derived from VDF, HFP, TFE and CTFE one or more of the followings:
recurring units derived from at least one bis-olefin [bis-olefin (OF)] having general formula:

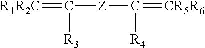

wherein R₁, R₂, R₃, R₄, R₅ and R₆, equal or different from each other, are H, a halogen, or a C1-C5 optionally halogenated group, possibly comprising one or more oxygen group; Z is a linear or branched C1-C18 optionally halogenated alkylene or cycloalkylene radical, optionally containing oxygen atoms, or a (per)fluoropolyoxyalkylene radical;
recurring units derived from at least one fluorinated monomer different from VDF, HFP; TFE and CTFE and
recurring units derived from at least one hydrogenated monomer,
recurring units derived from one or more cure sites containing monomers.

Examples of hydrogenated monomers which can be used herein are notably non-fluorinated alpha-olefins, including ethylene, propylene, 1-butene, diene monomers, styrene monomers, alpha-olefins being typically used. C2-C8 non-fluorinated alpha-olefins (OI), and more particularly ethylene (E) and propylene (F), will be selected for achieving increased resistance to bases.

The bis-olefin (OF) is preferably selected from the group consisting of those complying with formulae (OF-1), (OF-2) and (OF-3):

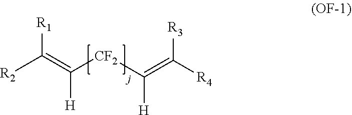

wherein j is an integer between 2 and 10, preferably between 4 and 8, and R₁, R₂, R₃, R₄, equal or different from each other, are H, F or C₁₋₅ alkyl or (per)fluoroalkyl group; a preferred bis-olefin of (OF-1) type is H₂C═CH—(CF₂)₆—CH═CH₂.

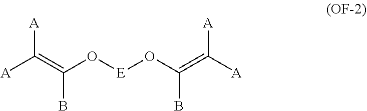

wherein
each of A, equal or different from each other and at each occurrence, is independently selected from F, Cl, and H;
each of B, equal or different from each other and at each occurrence, is independently selected from F, Cl, H and OR_{B}, wherein R_{B} is a branched or straight alkyl chain, which can be partially, substantially or completely fluorinated or chlorinated;
E is a divalent group having 2 to 10 carbon atom, optionally fluorinated, which may be inserted with ether linkages; preferably E is a —(CF₂)ₘ— group, with m being an integer from 3 to 5;
a preferred bis-olefin of (OF-2) type is F₂C═CF—O—(CF₂)₅—O—CF═CF₂.

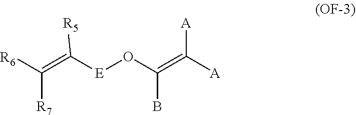

wherein E, A and B have the same meaning as above defined; R₅, R₆, R₇, equal or different from each other, are H, F or C₁₋₅ alkyl or (per)fluoroalkyl group.

When one or more bis-olefin is employed, the resulting fluoroelastomer A typically comprises from 0.01% to 5% by moles of units deriving from the one or more bis-olefin with respect to the total amount of units of said fluoroelastomer A.

Optionally, said fluoroelastomer A may comprise cure-site containing recurring units, i.e. units derived from monomers possessing cure sites.

Among cure-site containing recurring units, mention can be notably made of:
(CSM-1) iodine or bromine containing monomers of formula:

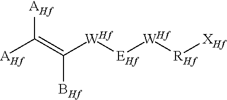

wherein each of A_{Hf}, equal to or different from each other and at each occurrence, is independently selected from F, Cl, and H; B_{Hf} is any of F, Cl, H and OR^{Hf}_{B}, wherein RH^{Hf}_{B} is a branched or straight chain alkyl radical which can be partially, substantially or completely fluorinated or chlorinated; each of W^{Hf} equal to or different from each other and at each occurrence, is independently a covalent bond or an oxygen atom; E_{Hf} is a divalent group having 2 to 10 carbon atom, optionally fluorinated; R_{Hf} is a branched or straight chain alkyl radical, which can be partially, substantially or completely fluorinated; and R_{Hf} is a halogen atom selected from the group consisting of Iodine and Bromine; which may be inserted with ether linkages; preferably E is a —(CF₂)ₘ— group, with m being an integer from 3 to 5;
(CSM-2) ethylenically unsaturated compounds comprising cyanide groups, possibly fluorinated.

Among cure-site containing monomers of type (CSM1), preferred monomers are those selected from the group consisting of: (CSM1-A) iodine-containing perfluorovinylethers of formula:

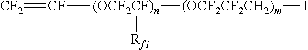

with m being an integer from 0 to 5 and n being an integer from 0 to 3, with the provision that at least one of m and n is different from 0, and R_{fi} being F or CF₃; (as notably described in U.S. Pat. No. 4,745,165 (AUSIMONT S.P.A.) U.S. Pat. No. 4,564,662 (MINNESOTA MINING) and EP199138 A (DAIKIN IND., LTD.); and
(CSM-1B) iodine-containing ethylenically unsaturated compounds of formula:

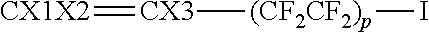

wherein each of X1, X2 and X3, equal to or different from each other, are independently H or F; and p is an integer from 1 to 5; among these compounds, mention can be made of CH₂═CHCF₂CF₂I, I(CF₂CF₂)₂CH═CH₂, ICF₂CF₂CF═CH₂, I(CF₂CF₂)₂CF═CH₂;
(CSM-1C) iodine-containing ethylenically unsaturated compounds of formula:

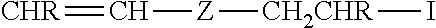

wherein R is H or CH₃, Z is a C1-C18 (per)fluoroalkylene radical, linear or branched, optionally containing one or more ether oxygen atoms, or a (per)fluoropolyoxyalkylene radical; among these compounds, mention can be made of CH₂═CH—(CF₂)₄CH₂CH₂I, CH₂═CH—(CF₂)₆CH₂CH₂I, CH₂═CH—(CF₂)₈CH₂CH₂I, CH₂═CH—(CF₂)₂CH₂CH₂I;
(CSM-1D) bromo and/or iodo alpha-olefins containing from 2 to 10 carbon atoms such as bromotrifluoroethylene or bromotetrafluorobutene described, for example, in U.S. Pat. No. 4,035,565 (DU PONT) or other compounds bromo and/or iodo alpha-olefins disclosed in U.S. Pat. No. 4,694,045 (DU PONT).

Among cure-site containing monomers of type (CSM2), preferred monomers are those selected from the group consisting of:
(CSM2-A) perfluorovinyl ethers containing cyanide groups of formula CF₂═CF—(OCF₂CFX^{CN})ₘ—O—(CF₂)ₙX^{CN}, with X^{CN} being F or CF₃, m being 0, 1, 2, 3 or 4; n being an integer from 1 to 12;
(CSM2-B) perfluorovinyl ethers containing cyanide groups of formula CF₂═CF—(OCF₂CFX^{CN})ₘ′-O—CF₂—CF(CF₃)—CN, with X^{CN} being F or CF₃, m′ being 0, 1, 2, 3 or 4.

Specific examples of cure-site containing monomers of type CSM2-A and CSM2-B suitable to the purposes of the present invention are notably those described in U.S. Pat. No. 4,281,092 (DU PONT), U.S. Pat. No. 5,447,993 (DU PONT) and U.S. Pat. No. 5,789,489 (DU PONT).

When one or more cure site containing monomer is employed, the resulting fluoroelastomer A typically comprises from 0.01% to 5% by moles of units deriving from the one or more cure site containing monomer with respect to the total amount of units of said fluoroelastomer A.

More preferred fluoroelastomers A are those comprising vinylidene fluoride (VDF) 35-80%, hexafluoropropene (HFP) 10-45%, tetrafluoroethylene (TFE) 0-30%, perfluoroalkyl vinyl ethers (PAVE) 0-15%, bis-olefin (OF) 0-5%, cure site containing monomers 0-5%.

Even more preferably fluoroelastomer (A) has iodine and/or bromine chain ends, and does not comprise cure site containing monomers as the iodine/bromine chain ends typically derive from chain transfer agents (as explained below) and already provide for effective cure site for crosslinking.

The method of the present invention includes a step wherein an aqueous emulsion is formed, in the absence of fluorinated surfactants, said aqueous emulsion comprising:
i) one or more polycarboxylic acid having from 2 to 22, preferably from 2, 16, more preferably from 2 to 12, even more preferably from 2 to 10 carbon atoms, in acid or salt form
iii) a free-radical initiator
ii) vinylidene fluoride (VDF) and one or more fluorinated monomer different from VDF
iv) optionally a chain transfer agent

A first essential component of the emulsion of the present invention is one or more polycarboxylic acid having from 2 to 22, preferably from 2, 16, more preferably from 2 to 12, even more preferably from 2 to 10 carbon atoms. Preferably the one or more polycarboxylic acid is selected from dicarboxylic and tricarboxylic acids, even more preferably from dicarboxylic acids. A polycarboxylic acid is an organic acid having more than one carboxylic group. Any polycarboxylic acid having from 2 to 22 carbon atoms can be used in present invention. It can be used equally in acid form or as an alkali metal or ammonium salt, so that, whenever in the present patent application a polycarboxylic acid (including tricarboxylic and dicarboxylic acids) is cited, the citation it is intended to encompass also its corresponding salt form. In general it is preferred that the pH of the aqueous emulsion is 7 or lower, typically such pH is directly obtained by mixing the required components when the polycarboxylic acid is in acid form, however, in case the polycarboxylic acid is introduced in salt form, the pH of the emulsion can also be adjusted as desired with conventional methods.

Preferred tricarboxylic acids are in particular citric acid and aconitic acid. Preferred dicarboxylic acids are compounds according to the formula (I)

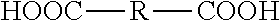

wherein R is a covalent bond or a C1-20 saturated or insaturated carbon chain which may carry substituents such as —OH groups. Preferably R is a covalent bond or a C1-C16 carbon chain, more preferably is a covalent bond or a C1-C12 carbon chain, most preferably is a covalent bond or a C1-C8 carbon chain. In some embodiment is a C1-C8 carbon chain. Insaturations in the chain R can be present but preferably the chain is saturated to reduce interference with the polymerization reaction. Substituents can be present on the chain R but preferably they are either absent or —OH. Examples of suitable dicarboxylic acids are for example oxalic acid, adipic acid, malonic acid, glutaric acid, fumaric acid, pimelic acid, azelaic acid, fumaric acid, maleic acid, suberic acid, sebacic acid.

Without being bound by theory it is believed that the polycarboxylic acids allow a fast progress of the emulsion polymerization and also contribute to stabilize the resulting latex and do not exhibit telogenic behavior.

Typically an effective total amount of one or more polycarboxylic acids in the aqueous emulsion of the present invention is at least from 0.05, preferably from 0.1, more preferably from 0.2 grams per liter of emulsion and at most 20, preferably at most 15, more preferably at most 10 grams per liter of emulsion.

Another essential component of the aqueous emulsion of the present invention is a free radical initiator. While the choice of the radical initiator is not particularly limited, it is understood that those suitable for the process according to the invention are selected from compounds capable of initiating and/or accelerating the polymerization process.

Inorganic radical initiators may be used and include, but are not limited to, persulfates such as sodium, potassium and ammonium persulfates, permanganates such as potassium permanganate.

Also, organic radical initiators may be used and include, but are not limited to, the followings: acetylcyclohexanesulfonyl peroxide; diacetylperoxydicarbonate; dialkylperoxydicarbonates such as diethylperoxydicarbonate, dicyclohexylperoxydicarbonate, di-2-ethylhexylperoxydicarbonate; tert-butylperneodecanoate; 2,2′-azobis(4-methoxy-2,4dimethylvaleronitrile; tert-butylperpivalate; dioctanoylperoxide; dilauroyl-peroxide; 2,2′-azobis (2,4-dimethylvaleronitrile); tert-butylazo-2-cyanobutane; dibenzoylperoxide; tert-butyl-per-2ethylhexanoate; tert-butylpermaleate; 2,2′-azobis(isobutyronitrile); bis(tert-butylperoxy)cyclohexane; tert-butyl-peroxyisopropylcarbonate; tert-butylperacetate; 2,2′-bis(tert-butylperoxy) butane; dicumyl peroxide; di-tert-amyl peroxide; di-tert-butyl peroxide (DTBP); p-methane hydroperoxide; pinane hydroperoxide; cumene hydroperoxide; and tert-butyl hydroperoxide.

Other suitable radical initiators notably include halogenated radical initiators such as chlorocarbon based and fluorocarbon based acyl peroxides such as trichloroacetyl peroxide, bis(perfluoro-2-propoxy propionyl) peroxide, [CF₃CF₂CF₂OCF(CF₃)COO]₂, perfluoropropionyl peroxides, (CF₃CF₂CF₂COO)₂, (CF₃CF₂COO)₂, {(CF₃CF₂CF₂)—[CF(CF₃)CF₂O]ₘ—CF(CF₃)—COO}₂ wherein m=0-8, [ClCF₂(CF₂)ₙCOO]₂, and [HCF₂(CF₂)ₙCOO]₂ wherein n=0-8; perfluoroalkyl azo compounds such as perfluoroazoisopropane, [(CF₃)₂CFN=]₂, RN═NR^{¤}, wherein R^{¤} is a linear or branched perfluorocarbon group having 1-8 carbons; stable or hindered perfluoroalkane radicals such as hexafluoropropylene trimer radical, [(CF₃)₂CF]₂(CF₂CF₂)C· radical and perfluoroalkanes.

Redox systems, comprising at least two components forming a redox couple, such as dimethylaniline-benzoyl peroxide, diethylaniline-benzoyl peroxide and diphenylamine-benzoyl peroxide may also be used as radical initiators to initiate the polymerization process.

Initiators are preferably selected among inorganic peroxides, and in particular, among persulfates.

As said, in the method of the invention, the amount of initiator (O) is of at least 1.50 and at most 100.00 mmol of O₂ per kg of fluoroelastomer (A). Such amount is expressed in terms of mmoles (millimoles) of —O—O-(peroxide) moieties in the said initiator (O), and is representative of the amount of active oxygen atoms which contributes to the creation of radical species.

For any initiator (O) which does not comprise any peroxide moiety, the mmoles of —O—O-(peroxide) moieties in the said initiator (O) can be equally determined based on the decomposition mechanism leading to the creation of radical species; an organic azo group is notably known to decompose with eliminating nitrogen and generating two radical species, and hence it is equivalent, in terms of radical species' creation, to —O—O-(peroxide) moieties.

A further optional component of the aqueous emulsion of the present invention is a chain transfer agent. The choice of chain transfer agent is not particularly limited however, since the resulting polymer is a fluoroelastomer it is typically beneficial that a fluoroelastomer includes cure sites so that the fluoroelastomer can be vulcanized.

One way of introducing cure sites in a fluoroelastomer is to create terminal groups of the fluoroelastomer (A) chain including iodine or bromine atoms, preferably iodine. Such iodine and/or bromine chain ends, are obtained, as known in the art, by addition to the polymerization medium during fluoroelastomer manufacture of at least one iodinated/brominated chain transfer agent [agent (CTA-X)]. Said agent (CTA-X) is preferably selected from the group consisting of:
iodinated and/or brominated organic chain-transfer agent(s); suitable organic chain-transfer agents are typically those of formula R_{f}(I)ₓ(Br)_{y}, in which R_{f} is a (per)fluoroalkyl or a (per)fluorochloroalkyl containing from 1 to 8 carbon atoms, while x and y are integers between 0 and 2, with 1≤x+y≤2 (see, for example, U.S. Pat. No. 4,243,770 (DAIKIN IND., LTD.) and U.S. Pat. No. 4,943,622 (NIPPON MEKTRON KK.); and
alkali metal or alkaline-earth metal iodides and/or bromides, such as described notably in U.S. Pat. No. 5,173,553 (AUSIMONT SRL.).

This said, preferred agents (CTA-X) are iodinated and/or brominated organic chain-transfer agent(s), more preferably those of formula R_{f}(I)ₓ(Br)_{y}, in which R_{f} is a (per)fluoroalkyl or a (per)fluorochloroalkyl containing from 1 to 8 carbon atoms, while x and y are integers between 0 and 2, with 1≤x+y≤2, and most preferably those of formula R′_{f}(I)_{x′}(Br)_{y′}, in which R′_{f} is a perfluoroalkyl containing from 1 to 8 carbon atoms, while x′ and y′ are integers between 0 and 2, with 1≤x′+y′≤2, most preferably x′=2 and y′=0.

In the method of the present invention, agents (CTA-X) which are iodinated are preferred, in particular those of formula R_{f}(I)₂ or R′_{f}(I)₂ with R_{f} and R′_{f} being as above detailed.

As known in the art and already mentioned above, another way of introducing cure sites in a fluoroelastomer is to copolymerize cure site monomers with the required fluoromonomers. In that case, or in case a fluoroelastomer not including cure sites is desired, the method of present invention can be performed without the addition of a chain transfer agent.

When using a chain transfer agent the amount typically used is of from 1 to 100 mmol of I and/or Br per kg of fluoroelastomer.

The aqueous emulsion of the present invention also comprises monomers comprising VDF and one or more fluorinated monomers different from VDF, the composition of monomers can be varied during the polymerization process as known to the skilled person and is selected in such a way to obtain the desired fluoroelastomer A comprising 30-80% by moles of recurring units derived from vinylidene fluoride (VDF), and 20-70% by moles of recurring units derived from one or more fluorinated monomer different from vinylidene fluoride (VDF) as described above.

A further step in the process of the present invention is to initiate the polymerization of said monomers. This is typically achieved by putting the monomers and the free radical initiator in contact through a water based reaction medium, typically the aqueous emulsion described above, maintained in agitation in a sealed reactor at a set pressure and temperature. As common in radical polymerization after the polymerization is initiated monomers and optionally initiator and/or chain transfer agent are typically continuously fed in the reactor until completion of the polymerization reaction so that, at the end of the polymerization process the total amount of free radical initiator and, if present, of chain transfer agent is loaded into the reactor.

Once the polymerization reaction is complete, a stable latex comprising particles of fluoroelastomer A is obtained.

As mentioned above, in the method of the present invention, said emulsion polymerization is carried out in the absence of any added fluorinated surfactant.

Examples of fluorinated surfactants which are not used in the present invention are fluorinated surfactants complying with the following formula:

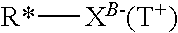

wherein
R* is a C5-C16 (per)fluoroalkyl chain or a (per)fluoropolyoxyalkylenic chain including one or more than one ethereal oxygen,
X^{B-} is —COO⁻ or —SO₃⁻,
T⁺ is selected from: H⁺, NH₄⁺, and an alkaline metal ion.

Specifically fluorinated surfactants which are used herein are those corresponding to the general formula:

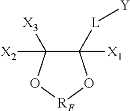

wherein X₁, X₂, X₃, equal or different from each other are independently selected among H, F, and C1-6 (per)fluoroalkyl groups, optionally comprising one or more catenary or non-catenary oxygen atoms; L represents a bond or a divalent group; RF is a divalent fluorinated C1-3 bridging group; Y is a hydrophilic function selected among anionic functionalities, cationic functionalities and non-ionic functionalities.

Exemplary embodiments of fluorinated surfactants which are not added in the method of the present invention are notably: ammonium perfluoro-octanoate; (per)fluoropolyoxy-alkylenes ended with one or more carboxylic groups, optionally salified with sodium, ammonium and alkaline metals; and partially fluorinated alkylsulphonates and compounds of formula:

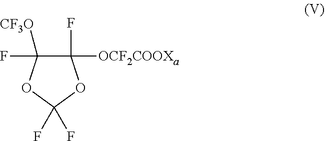

wherein Xa is an alakaline metal or ammonium moiety.

In a preferred embodiment, the process of the present invention is conducted in the presence of one or more non fluorinated surfactant. It is preferred that such non fluorinated surfactant is free from sulphur containing groups, such as sulfates and sulfonates surfactants. Such S containing surfactants are non preferred because they can cause a reduced color quality of the resulting fluoroelastomer.

More in general, in order to obtain a better color quality, it is preferred that aqueous emulsion of the present invention is essentially free from any compounds containing sulfur atoms considering both surfactants and not surfactant compounds.

Both anionic, cationic and non-ionic surfactants can be used herein, provided they do not contain fluorine atoms, preferred surfactants for use herein are anionic and non ionic surfactants, more preferred are non-ionic surfactants and in particular surfactants based on polyethylene glycol (PEG) and polypropylene glycol (PPG) repeating units. Particularly preferred non ionic surfactants are PEG/PPG block copolymers such as those marketed by BASF under the brand PLURONIC® and by Solvay under the brand name ANTAROX®.

When using a non fluorinated surfactant it is preferred that such non fluorinated surfactant is passivated. The use of a passivated surfactant allows to obtain a higher molecular weight polymer and a faster initiation and polymerization time.

The passivation of the non fluorinated surfactant is preferably carried out by reacting the surfactant with an oxidizing agent. Preferably, the oxidizing agent is hydrogen peroxide or a free radical initiator selected from the list previously presented. A preferred way to conduct passivation of the surfactant is to heat the surfactant together with the oxidizing agent in a water solution at a temperature at which the oxidizing agent is effective in generating radicals. Preferably the surfactant is heated at least at a temperature Tₕ wherein said oxidizing agent at said temperature Tₕ has a half-life of 1 hour. Half-life times of oxidizing agents as a function of temperature can be found in the technical literature e.g. at https://polymerdatabase.com/polymer % 20chemistry/t-alf2.html More preferably the surfactant is maintained at said temperature of at least Tₕ for 10 minute or more, preferably for 10-120 minutes, more preferably for 20-60 minutes.

Preferably the passivation of the surfactant is conducted before the initiation of the polymerization.

One method which can be used is to passivate the non fluorinated surfactant before it is introduced into the aqueous emulsion of the invention either as pure material or in mixture with other components of the emulsion provided that monomers are not present during the passivation process.

A preferred method for forming the aqueous emulsion of the invention containing a passivated surfactant includes:
forming first an aqueous mixture comprising said one or more dicarboxylic acids, said non fluorinated surfactant and said oxidizing agent, wherein the aqueous mixture does not comprise monomers,
then heating said aqueous mixture at least at a temperature Tₕ, wherein said oxidizing agent at said temperature Tₕ has a half-life of 1 hour, (preferably maintaining said temperature for 10 minute or more, preferably for 10-120 minutes, more preferably for 20-60 minutes) thus forming a passivated aqueous mixture, then
forming an aqueous emulsion comprising said passivated aqueous mixture, a free radical initiator, monomers comprising vinylidene fluoride (VDF) and one or more fluorinated monomer different from VDF and optionally a chain transfer agent, wherein all components are as described above and wherein the free radical initiator can be the same or different than the oxidizing agent used in the passivation step.

Typically an effective total amount of non fluorinated surfactant in the aqueous emulsion of the present invention is at least from 0.05, preferably from 0.1, more preferably from 0.2 grams per liter of emulsion and at most 20, preferably at most 15, more preferably at most 10 grams per liter of emulsion.

Advantageously, the method of the present invention comprises polymerizing VDF with at least one further fluorinated monomer different from VDF as defined above, in an aqueous emulsion.

The method according to the present invention can be preferably performed in continuous, or semi-batch or batch.

The method of the present invention is performed at a temperature that can be selected from the person skilled in the art, notably on the basis of the free radical initiator employed. Preferably, the method of the present invention is performed at a temperature from 40° C. to 120° C., more preferably from 50° C. to 100° C.

The method of the present invention is preferably performed at a pressure between 10 and 60 bars, more preferably from 20 to 55 bars.

As said, another object of the invention is an aqueous latex, free from fluorinated surfactants, comprising one or more dicarboxylic acid in acid or salt form and particles of a fluoroelastomer A, wherein said particles of fluoroelastomer A have an average particle size measured according to ISO 13321 below 400 nm, preferably below 350 nm, more preferably below 300, even more preferably below 270 nm, most preferably below 220 nm, and wherein said fluoroelastomer A:
comprises 30-80% by moles of recurring units derived from VDF, 20-70% by moles of recurring units derived from one or more fluorinated monomer different from VDF
possesses a Mooney viscosity (ML1+10 (121° C.)) of at least 10 MU;
comprises —CH₂OH chain ends in an amount of zero to less than 10,
preferably less than 5 mmol/kg of fluoroelastomer A.

In some embodiment a fluoroelastomer A in an aqueous latex according to the present invention comprises hydrogen-comprising chain ends selected from the group consisting of —CF₂H and —CF₂CH₃ in an amount of 15 to 100 mmol/kg of fluoroelastomer.

Said latex can be produced by emulsion polymerization without addition of any fluorinated surfactant as described above.

As said, the fluoroelastomer (A) possesses a Mooney viscosity (ML1+10) at 121° C. of at least 10, preferably at least 15, more preferably at least 20 Mooney Unit (MU), when determined according to ASTM D1646; and/or a Mooney Viscosity (ML1+10) at 121° C. of at most 80, preferably at most 75, more preferably at most 70 MU. In other terms, the fluoroelastomer (A) is a high molecular weight polymer, and not a fluorowax or a fluororubber of limited molecular weight. Indeed, this is an important feature, as techniques for making fluororubber without the addition to fluorosurfactants may be failing in providing access to such high molecular weight materials.

Still, in a further aspect, the present invention relates to an fluoroelastomer (A), wherein said fluoroelastomer (A):
comprises 30-80% by moles of recurring units derived from VDF, 20-70% by moles of recurring units derived from one or more fluorinated monomer different from VDF
possesses a Mooney viscosity (ML1+10 (121° C.)) of at least 10 MU;
comprises —CH₂OH chain ends in an amount of zero to less than 10 mmol/kg of fluoroelastomer A, preferably less than 5 mmol/kg of fluoroelastomer A;
comprises hydrogen-comprising chain ends selected from the group consisting of —CF₂H and —CF₂CH₃ in an amount of 15 to 100 mmol/kg of fluoroelastomer A.

Said fluoroelastomer can be produced by emulsion polymerization without addition of any fluorinated surfactant.

Such fluoroelastomer (A) is advantageously obtained by coagulation according to standard techniques of the latex comprising particles of fluoroelastomer (A), as described above typically leading to fluoroelastomer granules or crumbs.

In a still further aspect, the present invention relates to a curable composition comprising such fluoroelastomer (A), and a curing agent.

Said curing agent can be selected among all agents typically used to cure elastomers, for example It can be selected among peroxides and in particular organic peroxides having at least two peroxide groups in their molecule.

Said organic peroxide is selected among those which are capable of generating radicals in the curing conditions.

Among the commonly used organic peroxides, mention can be made of dialkylperoxides, such as, for example di-terbutyl-peroxide and 2,5-dimethyl-2,5-di(terbutylperoxy) hexane; dicumyl peroxide; di-benzoyl peroxide; diterbutyl perbenzoate; di[1,3-dimethyl-3-(terbutylperoxy)butyl] carbonate.

The curable composition of the invention may further comprise:
(a) curing coagents, in amounts generally in the range of 0.5-10 phr, preferably 1-7 phr, with respect to the fluoroelastomer (A); among those commonly used are: triallyl-cyanurate; triallyl-isocyanurate (TAIC); tris (diallylamine)-s-triazine; triallylphosphite; N, N-diallyl-acrylamide; N,N,N′,N′-tetraallyl-malonamide; trivinyl-isocyanurate; 2,4,6-trivinyl-methyltrisiloxane; N,N′bisallylbicyclo-oct-7-ene-disuccinimide (BOSA); bis-olefins (OF), as described above, in particular bis-olefins of formula CH₂═CH—(CF₂)ₙ—CH═CH₂, triazines having the general formula:

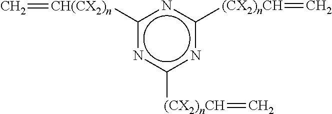

wherein X can be independently hydrogen, chlorine, fluorine C₁-C₃ alkyl or perfluoroalkyl; n is an integer in the range of 2-20, preferably 4-12, more preferably 4-8. TAIC is particularly preferred as curing coagent;
(b) a metal compound, in amounts in the range of 1-15 phr, 2-10 phr, with respect to the fluoroelastomer (A), selected from oxides or hydroxides of divalent metals, such as for instance, Mg, Zn, Ca or Pb, optionally associated with a weak acid salt, such as for example, Ba, Na, K, Pb, Ca stearates, benzoates, carbonates, oxalates or phosphites;
(c) other conventional additives, such as thickeners, pigments, antioxidants, reinforcing agents (e.g. carbon black), stabilizers and the like.

A method of making a cured part, and a cured part obtained from the curable composition above are additional objects of the present invention.

Said cured parts can be notably selected from pipes, joints, O-rings, hoses, and the like.

In a further aspect, the present invention relates to a method for the manufacture of a cured part, said method comprising processing and curing a curable composition comprising at least one fluoroelastomer (A), and at least one organic peroxide.

Said curable composition comprising fluoroelastomer (A) can be fabricated, e.g. by moulding (injection moulding, extrusion moulding), calendering, or extrusion, into the desired shaped article. The said cured part may be subjected to vulcanization (or curing) during the processing itself and/or in a subsequent step (post-treatment or post-cure).

Should the disclosure of any patents, patent applications, and publications which are incorporated herein by reference conflict with the description of the present application to the extent that it may render a term unclear, the present description shall take precedence.

The present invention will be now described in more detail with reference to the following examples, whose purpose is merely illustrative and not limitative of the scope of the invention.

### Experimental Section

### Materials Used

All polycarboxylic acids were sourced from Sigma-Aldrich.

Galden D02, VDF, HFP and TFE were obtained from Solvay Specialty Plymers Italia S.p.A.

Pluronic PE6200 is a commercial material from BASF.

### Mooney Viscosity:

Mooney viscosity (ML1+10) at 121° C. was measured according to ASTM D1646.

### Determination of Average Particle Size

Average particle size of the latex particles is measured via light scattering in accordance to ISO 13321.

### Determination of End Groups

End groups were identified and quantified by NMR and/or by infrared spectroscopy according to the method described in PIANCA, M., et al., J. Fluor. Chem. 1999, p. 95-71. In the table below, the qualification “n.d.” is used to mean “not detectable”, in connection with chain ends which are present in concentration lower than the limit of detection, i.e., lower than 0.05 mmol/Kg.

### Example 1

In a 2.2 L vertical autoclave, equipped with baffles and stirrer working at 650 rpm, were introduced after evacuation: 1.3 L of demineralized water, 1.3 g of pimelic acid, 1.8 grams of C₄F₈I₂ (3 ml of a 33% w solution of C₄F₈I₂ in Galden D02).

The autoclave was then sealed and heated to 80° C. and maintained at such temperature for the entire duration of the reaction. The pressure of the autoclave was increased by 9 bar by feeding HFP monomer. A gaseous mixture of the following monomers was fed to the autoclave so as to bring the pressure to 22 bar: vinylidene fluoride (VDF) 70% by moles, hexafluoropropene (HFP) 19% by moles and tetrafluoroethylene (TFE)₁₁% by moles. Then 35 ml of a water solution of ammonium persulfate at a concentration of 50 g/l were added (corresponding to 14 mmol O—O per kg of elastomer). After initiation, the VDF/HFP/TFE mixture was continuously fed to keep a constant pressure. The polymerization was continued until an overall monomer consumption of 550 g was reached. Then the autoclave was depressurized, vented and cooled.

### Example 2

Same procedure as in Ex. 1 was followed, except that azelaic acid was used instead of pimelic, the amount of APS was adjusted to 60 ml of 50 g/l solution (corresponding to 24 mmol O—O per kg of elastomer).

### Example 3

Same procedure as in Ex. 1 was followed, except that oxalic acid was used instead of pimelic, the amount of APS was adjusted to 50 ml of 50 g/l solution (corresponding to 20 mmol O—O per kg of elastomer).

### Example 4

Same procedure as in Ex. 1 was followed, except that 0.65 g of malonic acid were used instead of 1 g of pimelic, the amount of APS was adjusted to 105 ml of 50 g/l solution (corresponding to 42 mmol O—O per kg of elastomer).

### Example 5

Same procedure as in Ex. 1 was followed, except that 0.65 g of fumaric acid were used instead of 1 g of pimelic.

### Example 6

Same procedure as in Ex. 1 was followed, except that 0.65 g of itaconic acid were used instead of 1 g of pimelic, the amount of APS was adjusted to 78 ml of 50 g/l solution (corresponding to 31 mmol O—O per kg of elastomer).

### Example 7

In a 2.2 L vertical autoclave, equipped with baffles and stirrer working at 650 rpm, were introduced after evacuation: 1,3 L of demineralized water, 1,3 g of oxalic acid were added, 0.65 g of Pluronic PE6200 and 20 ml of APS solution at 50 g/l. The resulting mixture was heated at 70° C. for 60 minutes, then 3 ml of a 33% w solution of C₄F₈I₂ in Galden D02.

The autoclave was then sealed and heated to 80° C. and maintained at such temperature for the entire duration of the reaction. The pressure of the autoclave was increased by 9 bar by feeding HFP monomer. A gaseous mixture of the following monomers was fed to the autoclave so as to bring the pressure to 22 bar: vinylidene fluoride (VDF) 70% by moles, hexafluoropropene (HFP) 19% by moles and tetrafluoroethylene (TFE) 11% by moles. Then 50 ml of a water solution of ammonium persulfate at a concentration of 50 g/l were added (corresponding to 20 mmol O—O per kg of elastomer). After starting the polymerization, the VDF/HFP/TFE mixture was continuously fed to keep a constant pressure. The polymerization was continued until an overall monomer consumption of 550 g was reached. Then the autoclave was depressurized, vented and cooled.

### Example 8c (Comparative)

Same procedure as in Ex. 1 was followed, except that no dicarboxylic acid was added.

A portion of the latex obtained from Ex. 1-9 was then coagulated to extract fluoropolymer crumbs according to the following process:
In a glass becker 3 liters of demineralized water were heated up to 60° C. by a heating plate, then 6 grams of aluminum sulphate [Al₂ (SO₄)₃] were added and mixed to complete dissolution. Then 250 ml of latex, obtained according procedure in Example 1, were fed in the becker by the use of a dropping funnel stirred by an overhead stirrer. Once all the latex was fed, the solution is left under stirring till the complete coagulation of the polymer. The polymer was then washed with water and dried so to obtain fluoroelastomer crumbs. Mooney viscosity of the fluoroelastomers was measured on the dried fluoroelastomer crumbs.

Results shown in table 1 below highlight how the method of the present invention allows to obtain fluoroelastomer latexes having very low particle size and having outstanding stability if compared with the reference products having the same composition and being manufactured with the prior art method. The Mooney viscosity values obtained confirm that the fluoroelastomers obtained in the present method are suitable for many common applications of fluoroelastomers.

TABLE 1

| | E. 1 | E. 2 | E. 3 | E. 4 | E. 5 | E. 6 | E. 7 | E. 8c |
|---|---|---|---|---|---|---|---|---|
| Average | 340 | 258 | 312 | 264 | 277 | 309 | 189 | 352 |
| particle size | | | | | | | | |
| (nm) | | | | | | | | |
| Latex | 25 | 16 | 17 | 26 | 20 | 18 | >90 | 3 |
| stability | | | | | | | | |
| (days) | | | | | | | | |
| Mooney | 66 | 53 | 70 | 121 | 142 | 47 | 32 | 165 |
| viscosity | | | | | | | | |

1. A method of making a fluoroelastomer [fluoroelastomer A] in an aqueous reaction medium free from fluorinated surfactants said method comprising:
a: forming an aqueous emulsion comprising:
i) one or more polycarboxylic acid having from 2 to 22 carbon atoms, in acid or salt form,
iii) a free-radical initiator,
ii) monomers comprising vinylidene fluoride (VDF) and one or more fluorinated monomer different from VDF,
iv) optionally a chain transfer agent;
b: initiating the polymerization of said monomers, thereby forming a fluoroelastomer [fluoroelastomer A] as a stable latex,
wherein:
said fluoroelastomer A comprises 30-80% by moles of recurring units derived from vinylidene fluoride (VDF), and 20-70% by moles of recurring units derived from one or more fluorinated monomer different from VDF.

2. The method of claim 1 wherein said aqueous emulsion also comprises one or more non fluorinated surfactant.

3. The method of claim 2 wherein said one or more non fluorinated surfactant is selected from non ionic surfactants and wherein said aqueous emulsion is free from surfactants comprising sulphur.

4. The method of claim 2 wherein said one or more non fluorinated surfactant is passivated.

5. The method of claim 3 wherein said non ionic surfactant is a polyethylene glycol-polypropylene glycol block copolymer.

6. The method according to claim 1 wherein said free radical initiator is selected from inorganic free radical initiators.

7. The method according to claim 1 wherein said one or more fluorinated monomer different from VDF is selected from hexafluoropropylene (HFP), tetrafluoroethylene (TFE), perfluoroalkylvinylethers (PAVE), chlorotrifluoroethylene (CTFE).

8. The method according to claim 1 also including the additional step of coagulating said fluoroelastomer A and separating it from said latex as fluoroelastomer crumbs.

9. An aqueous latex, free from fluorinated surfactants, comprising one or more polycarboxylic acid having from 2 to 22 carbon atoms, in acid or salt form, and particles of a fluoroelastomer A, wherein said particles of fluoroelastomer A have an average particle size, measured according to ISO 13321, below 400 nm and wherein said fluoroelastomer A:
comprises 30-80% by moles of recurring units derived from VDF, 20-70% by moles of recurring units derived from one or more fluorinated monomer different from VDF,
possesses a Mooney viscosity (ML1+10 (121° C.)) of at least 10 MU, and
comprises —CH₂OH chain ends in an amount of zero to less than 10 mmol/kg of fluoroelastomer A.

10. The aqueous latex of claim 9 wherein said fluoroelastomer A comprises hydrogen-comprising chain ends selected from the group consisting of —CF₂H and —CF₂CH₃ in an amount of 15 to 100 mmol/kg of fluoroelastomer A.

11. A fluoroelastomer A possessing a Mooney viscosity (ML1+10 (121° C.)) of at least 10 MU;
and comprising:
30-80% by moles of recurring units derived from VDF, 20-70% by moles of recurring units derived from one or more fluorinated monomer different from VDF,
CH₂OH chain ends in an amount of zero to less than 10 mmol/kg of fluoroelastomer A, and
hydrogen-comprising chain ends selected from the group consisting of —CF₂H and —CF₂CH₃ in an amount of 15 to 100 mmol/kg of fluoroelastomer A.

12. The fluoroelastomer according to claim 11 which is produced by emulsion polymerization without addition of any fluorinated surfactant.

13. A curable composition comprising the fluoroelastomer A according to claim 11 and one or more curing agents.

14. A method for making a cured part, said method comprising processing and curing the curable composition according to claim 13.

15. A cured part obtained from the method of claim 14.
